(19) United States
(12) Patent Application Publication
(10) Pub. No.: US 2019/0214934 A1
(43) Pub. Date: Jul. 11, 2019

(54) MOTOR SYSTEM, ANALYSIS DEVICE, AND ELECTRICAL APPLIANCE

(71) Applicant: Nidec Corporation, Kyoto (JP)

(72) Inventors: Tatsushi NAKAHO, Kyoto (JP); Yusuke WATANABE, Kyoto (JP); Takuya YAMANE, Kyoto (JP)

(21) Appl. No.: 16/355,878

(22) Filed: Mar. 18, 2019

Related U.S. Application Data
(63) Continuation of application No. PCT/JP2017/030469, filed on Aug. 25, 2017.

(30) Foreign Application Priority Data
Sep. 29, 2016 (JP) 2016-190614

(51) Int. Cl. H02P 29/60; G05B 23/02; G05B 11/36; G05B 13/02; H02P 5/74; H02P 5/50; H02P 29/40

(52) U.S. Cl. CPC H02P 29/60; G05B 23/02; G05B 11/36; H02P 29/40; H02P 5/74; H02P 5/50; G05B 13/02

(57) ABSTRACT

A motor system includes an electrical appliance including a motor, a drive circuit to drive the motor based on a rewritable drive control parameter, and a detector to detect drive information of the motor, and an analyzer including a calculator. The drive information detected by the detector is output to an outside of the electrical appliance and transmitted to the calculator, the calculator performs adjustment of the drive control parameter based on the drive information transmitted, and the drive control parameter after the adjustment is transmitted to and set in the drive circuit.

### CROSS REFERENCE TO RELATED APPLICATIONS

This application claims the benefit of priority to Japanese Patent Application No. 2016-190614 filed on Sep. 29, 2016 and is a Continuation Application of PCT Application No. PCT/JP2017/030469 filed on Aug. 25, 2017. The entire contents of each application are hereby incorporated herein by reference.

### FIELD OF THE INVENTION

The present disclosure relates to a motor system, an analysis device, and an electrical appliance.

### BACKGROUND

Various motor systems have hitherto been proposed, and for example, the following motor system is disclosed.

A conventional motor system includes a motor and a motor control device. The motor includes an encoder and a microcomputer. The microcomputer includes a ROM. The ROM is configured to store model codes.

The motor control device is configured to read a model code from the ROM of the motor, select one of control parameters corresponding to the read model code, set the selected control parameter in a motor control unit, and start control of the motor.

In addition, the control parameters include a rewritable control parameter, and the motor control device can be connected with a PC for rewriting the rewritable control parameter.

According to the conventional motor system, however, the same control parameter is set if the motors are of the same model. This prevents suitable drive control according to individual characteristics of the motors. In addition, in the case where motors of the same model are mounted on different electrical appliances, drive control of the motors cannot be performed appropriately according to a disturbance factor (variations in the load state, etc.) due to individual characteristics of the electrical appliances.

According to the conventional motor system, the control parameter can be rewritten by an input operation by the PC, but drive control suitable for individual motors cannot be easily performed, since appropriate rewriting of the control parameter according to individual characteristics of the motors and individual characteristics of the electrical appliances largely depends on professional intuition of engineers.

### SUMMARY

A motor system according to an example embodiment of the present disclosure includes an electrical appliance including: a motor a drive circuit to drive the motor based on a rewritable drive control parameter, and a detector to detect drive information of the motor, and an analyzer including a calculator, wherein the drive information detected by the detector is output to an outside of the electrical appliance and transmitted to the calculator, the calculator performs adjustment of the drive control parameter based on the drive information transmitted, and the drive control parameter after the adjustment is transmitted to and set in the drive circuit.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 is a schematic diagram showing an appearance configuration of a motor system according to a first example embodiment of the present disclosure.

FIG. 2 is a front sectional view schematically showing a configuration example of a multifunction device.

FIG. 3 is a schematic block diagram of the motor system according to the first example embodiment of the present disclosure.

FIG. 4 is a schematic perspective view showing an example of a drive mechanism to drive a load by a motor.

FIG. 5A is a graph showing an example of an actual rotational speed in response to a speed command value.

FIG. 5B is a graph showing an example of an actual rotational speed in response to a speed command value.

FIG. 6 is a schematic diagram showing an appearance configuration of a motor system according to a second example embodiment of the present disclosure.

FIG. 7 is a schematic block diagram of the motor system according to the second example embodiment of the present disclosure.

FIG. 8 is an overview showing one example embodiment of the motor system according to the second example embodiment of the present disclosure.

### DETAILED DESCRIPTION

Hereinafter, example embodiments of the present disclosure will be described with reference to the drawings.

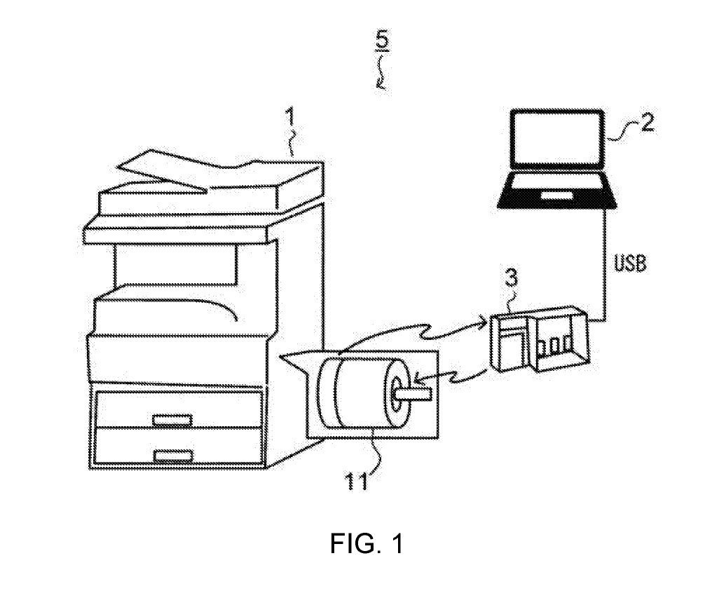

FIG. 1 is a schematic diagram showing an appearance configuration of a motor system according to a first example embodiment of the present disclosure. A motor system 5 according to the first example embodiment shown in FIG. 1 includes a multifunction device 1 as an example of an electrical appliance, a personal computer (PC) 2 as an example of an analysis device, and a measuring/writing device 3.

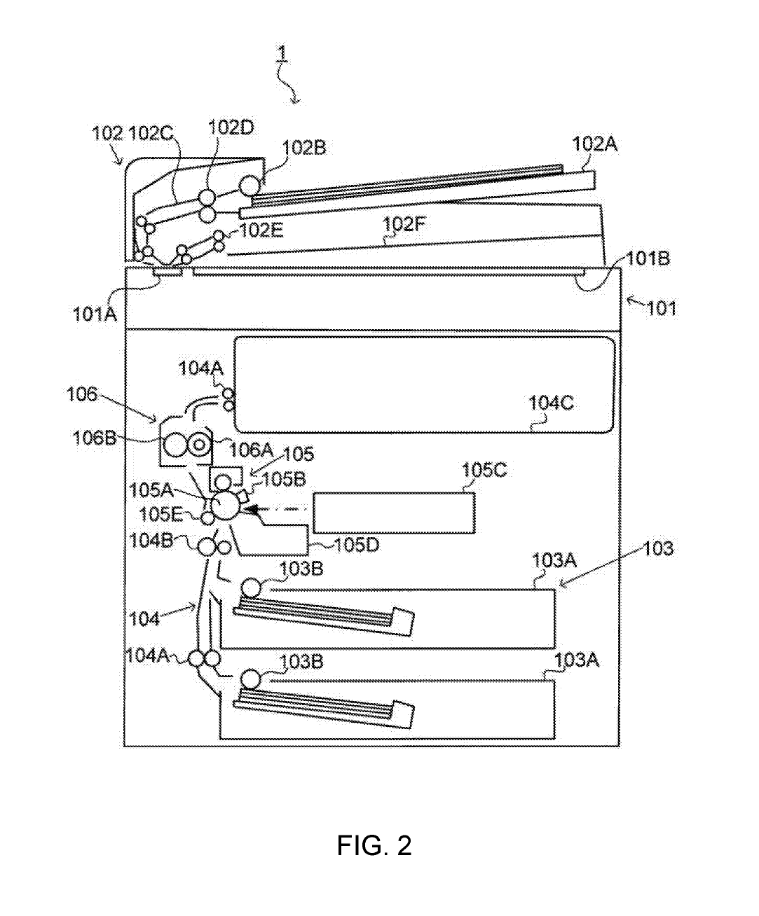

The multifunction device 1 includes a motor 11. Here, FIG. 2 is a front sectional view schematically showing a configuration example of the multifunction device 1. The multifunction device 1 shown in FIG. 2 includes an image reading unit 101, a document conveying unit 102, a sheet feeder unit 103, a conveying path 104, an image forming unit 105, and a fixing unit 106.

The image reading unit 101 is configured to irradiate a document with light and generate image data by an image sensor (not shown) based on the reflected light. An upper part of the image reading unit 101 includes a first contact glass 101A for reading a conveyed document and a second contact glass 101B for reading a placed document. The document conveying unit 102 is fixed to the image reading unit 101 in an openable manner in a vertical direction, and is configured to convey a document toward the first contact glass 101A. The document conveying unit 102 presses the first contact glass 101A and the second contact glass 101B from above.

The document conveying unit 102 includes a document tray 102A, a document feed roller 102B, a document conveying path 102C, a plurality of document conveying roller pairs 102D, a document discharge roller pair 102E, and a document receiving tray 102F.

A document placed on the document tray 102A is fed to the document conveying path 102C by rotation of the document feed roller 102B. The fed document is conveyed by the document conveying roller pair 102D onto the first contact glass 101A through the document conveying path 102C.

The image reading unit 101 is configured to emit light through the first contact glass 101A toward the document conveyed onto the first contact glass 101A, and receive the reflected light with the image sensor to generate image data. The read document is conveyed downstream by the document conveying roller pair 102D, and discharged by the document discharge roller pair 102E onto the document receiving tray 102F.

Further, the image reading unit 101 is also configured to emit light to a document placed on the second contact glass 101B and generate image data based on the reflected light.

The multifunction device 1 is configured to print based on the image data generated by reading the conveyed or placed document. A copy of the document is thus obtained.

The sheet feeder unit 103, the conveying path 104, the image forming unit 105, and the fixing unit 106 are provided for the purpose of printing.

The sheet feeder unit 103 includes cassettes 103A and sheet feeding rollers 103B. The sheet feeding rollers 103B are configured to rotate, and by the rotation of the sheet feeding rollers 103B, the sheets stored in the respective cassettes 103A are sent one by one to the conveying path 104.

The conveying path 104 is a path for conveying the sheet supplied from the sheet feeder unit 103. The image forming unit 105 and the fixing unit 106 are disposed on a path along which the sheet is conveyed by the conveying path 104. The conveying path 104 has a conveying guide for guiding the sheet, a plurality of conveying roller pairs 104A that are rotationally driven at the time of sheet conveyance, a registration roller pair 104B, and a receiving tray 104C. The registration roller pair 104B is configured to place the conveyed sheet on standby before the image forming unit 105, and send out the sheet at an appropriate timing.

The image forming unit 105 is configured to form a toner image based on the image data, and transfer the toner image to the conveyed sheet. The image forming unit 105 includes a photosensitive drum 105A, a charging device 105B, an exposure device 105C, a development device 105D, and a transfer roller 105E. The photosensitive drum 105A is configured to rotate.

The charging device 105B is configured to electrically charge the photosensitive drum 105A to a predetermined potential. The exposure device 105C is configured to emit a laser beam based on the image data, and scan and expose the surface of the photosensitive drum 105A with the laser beam. As a result, an electrostatic latent image corresponding to the image data is formed on the photosensitive drum 105A. The development device 105D is configured to supply toner to the electrostatic latent image and develop an image.

The transfer roller 105E is pressed against the photosensitive drum 105A to form a nip. The sheet that has been sent out in synchronization with the toner image enters the nip. At this time, a predetermined potential is applied to the transfer roller 105E, and the toner image on the photosensitive drum 105A is transferred to the sheet.

The fixing unit 106 fixes the toner image transferred onto the sheet. The fixing unit 106 includes a heating roller 106A incorporating a heater, and a pressure roller 106B. The pressure roller 106B is pressed against the heating roller 106A to form a nip. As the sheet passes through the nip, the toner is heated and melted, and the toner image is fixed on the sheet. The sheet on which the toner image has been fixed is discharged to the receiving tray 104C by the conveying roller pair 104A.

The image data used for printing may be data from a PC outside the multifunction device 1, or may be data from an external facsimile machine.

As described above, the multifunction device 1 includes various rollers provided, for example, in each of the document conveying unit 102, the sheet feeder unit 103, and the conveying path 104, and the multifunction device 1 also includes various motors for rotationally driving these rollers. The motor 11 is one of these motors. It should be noted that the motor 11 is not limited to a motor configured to rotate a roller, but may be a roller configured to rotate a photosensitive drum or the like, for example.

In addition, the multifunction device 1 is one example of an electrical appliance, and the electrical appliance may be an image forming device, such as a printer, a copier, a facsimile machine, or a product other than such an image forming device.

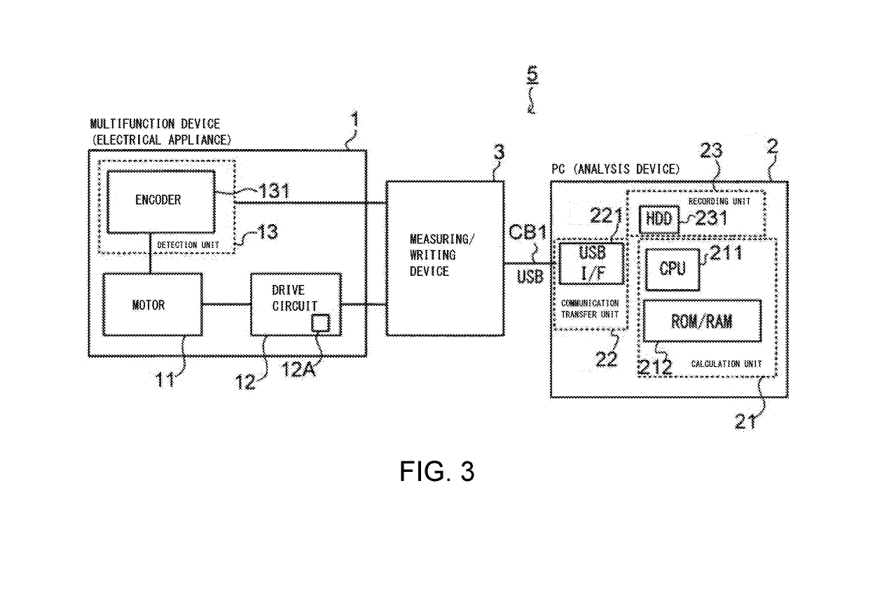

Here, FIG. 3 is a schematic block diagram of the motor system 5 shown in FIG. 1. FIG. 3 shows only the components related to driving of the motor 11 regarding the multifunction device 1.

The multifunction device 1 includes the motor 11, a drive circuit 12, and a detection unit 13. The motor 11 is formed of, for example, a brushless DC motor. The drive circuit 12 includes a microcomputer 12A, and is configured to perform drive control of the motor 11 based on a rewritable drive control parameter in the microcomputer 12A.

The drive circuit 12 forms a speed feedback control system for controlling the rotational speed of the motor 11, for example. In this case, the microcomputer 12A includes a speed comparison unit, a speed control unit, an electric current comparison unit, and an electric current control unit. The speed comparison unit is configured to compare the rotational speed of the motor 11 detected from the electric current flowing in the motor 11 with a speed command value. The speed control unit is configured to calculate an electric current command value based on a deviation signal output from the speed comparison unit. The electric current comparison unit is configured to compare a detected value of the electric current flowing in the motor 11 with the electric current command value. The electric current control unit is configured to generate, for example, a PWM pulse signal based on a deviation signal output from the electric current comparison unit.

The drive circuit 12 includes a switching element (not shown) in addition to the microcomputer 12A. The switching element is turned on or off according to the PWM pulse signal generated as described above to control energization of the motor 11. As a result, the rotational speed of the motor 11 is controlled to follow the speed command value. Such speed feedback control is performed by, for example, proportional-integral (PI) control, and a proportional gain, an integral gain, and the like are set in the microcomputer 12A as drive control parameters.

When the drive circuit 12 forms, for example, a position feedback control system, the microcomputer 12A includes a position comparison unit and an angle control unit in addition to the above-described configuration of the speed feedback control system. The position comparison unit is configured to compare the rotational position of the motor 11 determined based on the electric current flowing in the motor 11 and a position command value. The angle control unit is configured to calculate a speed command value based on a deviation signal output from the position comparison unit. A PWM pulse signal is generated based on the speed command value in the same manner as the speed feedback control. As a result, the rotational position of the motor 11 is controlled to meet the position command value. Such position feedback control is performed by proportional-integral-differential (PID) control, and a proportional gain, an integral gain, a differential gain, and the like are set in the microcomputer 12A as drive control parameters.

The multifunction device 1 includes an encoder 131 as an example of the detection unit 13. The encoder 131 is configured to detect drive information of the motor 11, such as the rotational speed and the rotational position, in a state of being mounted on the motor 11. An electric signal is output from the encoder 131 and is input to the measuring/writing device 3 provided outside the multifunction device 1.

The measuring/writing device 3 that is an example of a data acquisition unit has a Universal Serial Bus (USB) port, and is connected to a PC 2 by a USB cable CB1. The measuring/writing device 3 operates based on a control program stored in the PC 2 described later. The measuring/writing device 3 is configured to measure the rotational speed and the rotational position based on the electric signal input from the encoder 131. Further, the measuring/writing device 3 acquires command values, such as a speed command value, a position command value, from the drive circuit 12.

The PC 2 includes a calculation unit 21, a communication transfer unit 22, and a recording unit 23. The calculation unit 21 includes a central processing unit (CPU) 211 and a read only memory (ROM) or a random access memory (RAM) 212. The PC 2 includes a USB interface 221 as an example of the communication transfer unit 22. The USB interface 221 is connected with the USB cable CB1.

Further, the PC 2 includes a hard disk drive (HDD) 231 as an example of the recording unit 23. It should be noted that the recording unit 23 is not limited to the HDD, but may be formed of a semiconductor memory device, an optical disk device, or the like. The calculation unit 21 implements various programs stored in the HDD 231 to perform various processing. The programs include the above described control program for operating the measuring/writing device 3, and also include a program for adjustment of a drive control parameter described later.

The calculation unit 21 performs adjustment of the drive control parameter based on the drive information acquired from the measuring/writing device 3 via the USB interface 221. The drive control parameter after the adjustment is transmitted to the measuring/writing device 3 via the USB interface 221. The measuring/writing device 3 is configured to set the transmitted drive control parameter in the microcomputer 12A of the drive circuit 12.

Note that the measuring/writing device 3 may be provided outside the multifunction device 1 instead of inside the multifunction device 1. In such a case, the multifunction device 1 includes a USB port for connecting the USB cable CB1. As an alternative to the configuration in which writing to the microcomputer 12A is performed by the measuring/writing device 3, the PC 2 is directly connected to the drive circuit 12 through a serial cable (USB, RS-232C, or the like), and communicate with the microcomputer 12A by universal asynchronous receiver transmitter (UART) communication, for example.

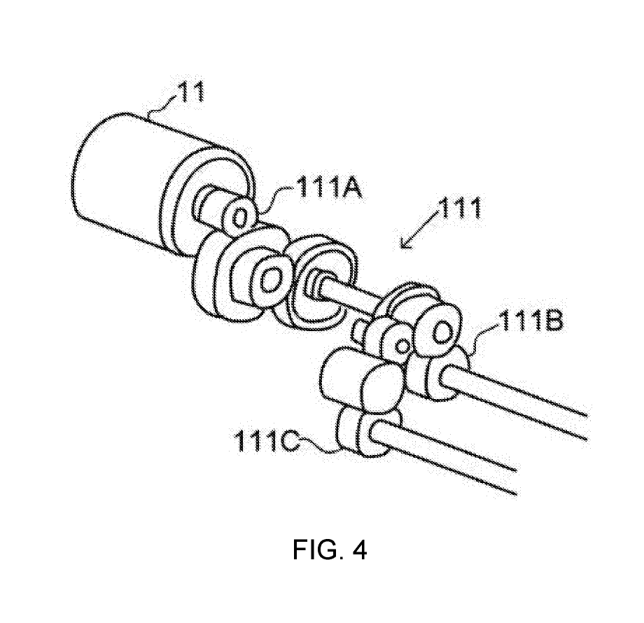

Here, FIG. 4 is a schematic perspective view showing an example of a drive mechanism for driving a load by the motor 11. A speed reduction mechanism 111 shown in FIG. 4 is formed of engagement of a plurality of gears. The motor 11 rotates a first-stage gear 111A of the speed reduction mechanism 111. The last-stage gears 111B, 111C of the speed reduction mechanism 111 respectively rotate rollers (not shown), for example.

In such a configuration, the moment of inertia of the motor 11 varies due to an individual characteristic of the motor 11, the moments of inertia of the speed reduction mechanism 111 and rollers (not shown) vary due to their individual characteristics, and backlash of the gears varies due to an individual characteristic of the speed reduction mechanism 111. Thus, the drive control parameter requires adjustment according to a disturbance factor caused by the individual characteristic of the motor 11 and the individual characteristic of the multifunction device 1 to optimize the drive control of the individual motor 11.

In view of the above, the motor system 5 according to the present example embodiment automatically performs such optimization of the drive control of the motor 11. The processing to optimize the drive control of the motor 11 according to the motor system 5 will be described below.

Here, an example of a processing to optimize the rotational speed control of the motor 11 will be described, as an example of the processing to optimize the drive control of the motor 11. It is desirable that the optimization of the drive control of the motor 11 is performed at an early stage when the multifunction device 1 is installed. For example, when the multifunction device 1 is installed in a customer's office or the like, a support staff member takes the PC 2 to the customer.

First, the drive circuit 12 performs PI control for speed feedback control of the motor 11 using a proportional gain and an integral gain for speed control, which are drive control parameters that has been preset in the microcomputer 12A of the drive circuit 12. In this case, the motor 11 is controlled such that the rotational speed thereof follows a predetermined speed command value, and the rotational speed is detected by the encoder 131.

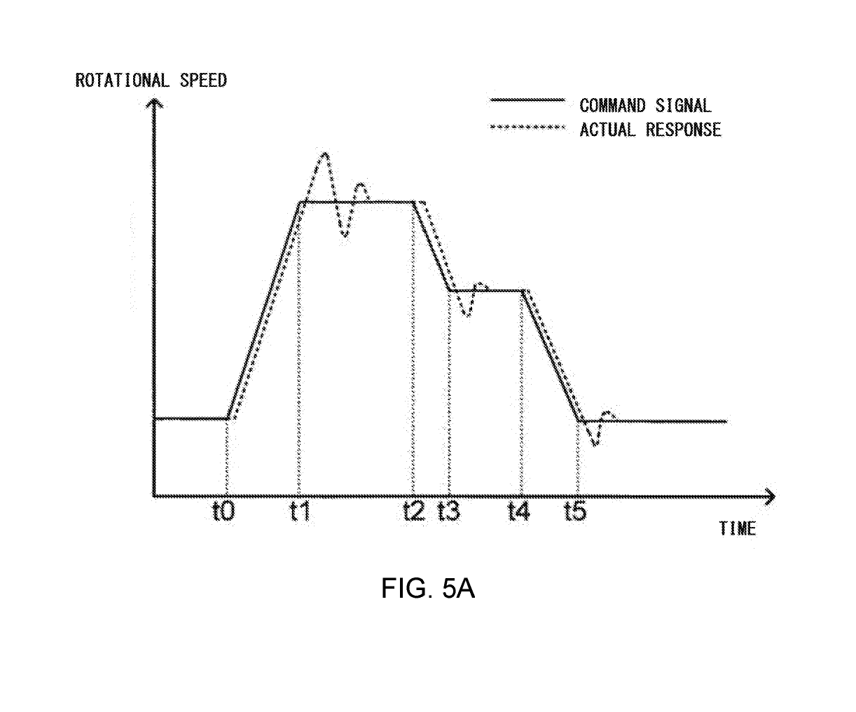

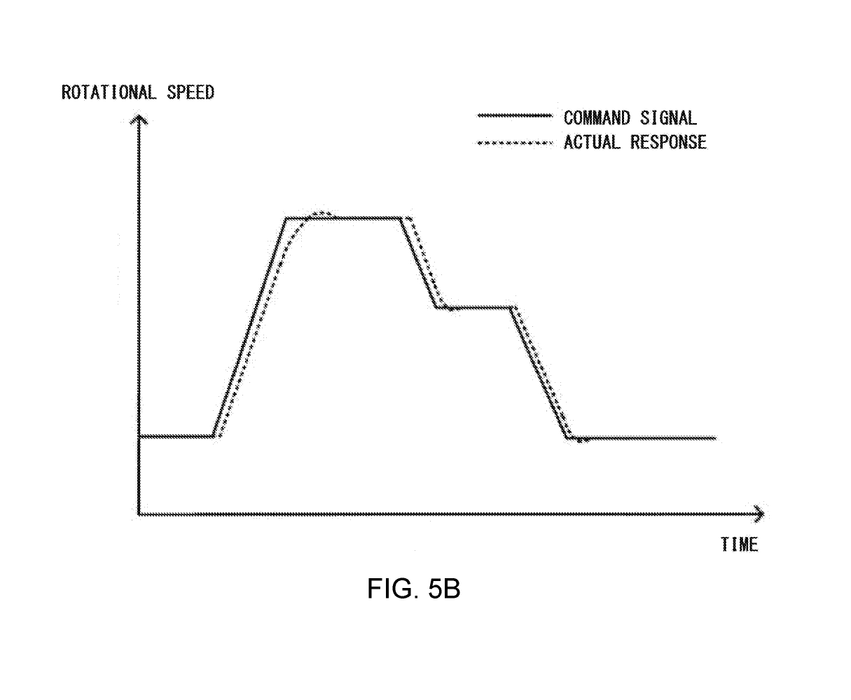

The rotational speed detected by the encoder 131 as the drive information and the speed command value are measured by the measuring/writing device 3 and transmitted to the calculation unit 21 via the USB interface 221. Here, FIG. 5A shows an example of an actual rotational speed in response to a speed command value. In the example of FIG. 5A, overshoot occurs as a response when the rotational speed is made constant after an acceleration period (time t0 to t1) in which the rotational speed accelerates from a state in which the rotation has been stopped. Thereafter, undershoot occurs as a response when the rotational speed is made constant after a deceleration period (time t2 to t3) in which the rotational speed is decreased. Thereafter, undershoot occurs as a response when the rotation is stopped after a deceleration period (time t4 to t5) in which the rotational speed decelerates.

The calculation unit 21 first performs adjustment of the proportional gain when the calculation unit 21 determines from the acquired drive information that the degrees of the overshoot and the undershoot that have occurred in the response to the speed command value of the rotational speed, exceed allowable limits. Then, the calculation unit 21 transmits the proportional gain after the adjustment to the measuring/writing device 3 via the USB interface 221. The measuring/writing device 3 sets the transmitted proportional gain in the microcomputer 12A of the drive circuit 12 by rewriting.

Then, the drive circuit controls the speed of the motor 11 using the set proportional gain. At this time, the rotational speed detected by the encoder 131 is measured by the measuring/writing device 3, and is transmitted to the calculation unit 21 via the USB interface 221.

The calculation unit 21 checks changes in the amount of overshoot and in the amount of undershoot of the response based on the previously transmitted drive information and the currently transmitted drive information. Next, the calculation unit 21 performs adjustment of the integral gain, and transmits the integral gain after the adjustment to the measuring/writing device 3 via the USB interface 221. At this time, the calculation unit 21 also transmits the proportional gain before the adjustment to the measuring/writing device 3. The measuring/writing device 3 sets the transmitted integral gain and proportional gain in the microcomputer 12A by rewriting.

Then, the drive circuit controls the speed of the motor 11 using the set proportional gain and integral gain. At this time, the rotational speed detected by the encoder 131 is measured by the measuring/writing device 3, and is transmitted to the calculation unit 21 via the USB interface 221.

The calculation unit 21 checks changes in the amount of overshoot and in the amount of undershoot of the response based on the drive information transmitted for the first time and the currently transmitted drive information. Then, the calculation unit 21 compares the adjustment of the proportional gain with the adjustment of the integral gain with respect to the influence on the changes in the amounts of overshoot and undershoot, and determines the gain with a larger degree of influence to be subjected to adjustment. Then, in consideration of the degree of influence, the calculation unit 21 performs adjustment of the gain such that the amounts of overshoot and undershoot of the response do not exceed the allowable limits.

Then, the calculation unit 21 transmits the gain after the adjustment to the measuring/writing device 3 via the USB interface 221. At this time, the calculation unit 21 also transmits to the measuring/writing device 3 the gain determined not to be subjected to adjustment. The measuring/writing device 3 rewrites and sets the gain of the microcomputer 12A with the transmitted gain.

Then, the drive circuit controls the speed of the motor 11 using the set proportional gain and integral gain. At this time, the rotational speed detected by the encoder 131 is measured by the measuring/writing device 3, and is transmitted to the calculation unit 21 via the USB interface 221.

The calculation unit 21 checks the transmitted drive information and checks whether the amounts of overshoot and undershoot of the response are within the allowable limits. The process ends when the amounts of overshoot and undershoot of the response are determined to be within the allowable limits, and the gain set in the microcomputer 12A is finally determined as an appropriate gain. Here, corresponding to FIG. 5A, FIG. 5B shows an example of a state in which the amounts of overshoot and undershoot of the response are within the allowable limits. In the present example embodiment, a preferable command value is employed as a speed command value, but the speed command value may have a certain range. For example, a speed command value may have a range of about 5% above and below a preferable command value. Thereby, the motor 11 can be flexibly controlled according to the drive characteristic of the motor 11 required for driving the electrical appliance 1.

Thereafter, the drive circuit 12 controls the speed of the motor 11 using the set gain. This makes it possible to properly set the drive control parameter according to a disturbance factor due to an individual characteristic of the motor 11 and an individual characteristic of the multifunction device 1 to adjust the speed control of the individual motor 11.

The motor system 5 according to the present example embodiment includes: an electrical appliance 1 including: a motor 11; a drive circuit 12 configured to drive the motor 11 based on a rewritable drive control parameter; and a detection unit 13 configured to detect drive information of the motor; and an analysis device 2 having a calculation unit 21, wherein the drive information detected by the detection unit is output to an outside of the electrical appliance and transmitted to the calculation unit, the calculation unit performs adjustment of the drive control parameter based on the drive information thus transmitted, and the drive control parameter after the adjustment is transmitted to and set in the drive circuit.

This configuration makes it possible to automatically perform adjustment of the drive control parameter according to a disturbance factor due to an individual characteristic of the motor 11 and an individual characteristic of the electrical appliance 1, and thus the driving control of the individual motor 11 is adjusted easily.

In optimizing the rotational speed control of the motor as described above, a drive control parameter subjected to adjustment is not limited to the proportional gain and the integral gain, and any other drive control parameters may be subjected to adjustment. In the above description, the gain with a larger degree of influence is determined to be subjected to adjustment, but multiple gains may be simultaneously subjected to adjustment. The adjustment of the proportional gain, the integral gain, the differential gain, and the like as the drive control parameters may be performed not only for optimizing the rotational speed control, but for optimizing the rotational position control of the motor 11, for example.

In addition, the multifunction device 1 includes a plurality of motors, and thus each of the plurality of motors in the multifunction device 1 forms a set of the motor 11, the drive circuit 12, and the encoder 131 shown in FIG. 3. For example, the set may be formed by each of the plurality of motors for driving the rollers in the document conveying unit 102, or may be formed by each of the plurality of motors including the motors for driving the rollers in the document conveying unit 102 and the motors for driving the rollers in the sheet feeder unit 103 and in the conveying path 104.

In such a case, the measuring/writing device 3 and the PC 2 are used in common for the plurality of motors. Then, the drive control is adjusted by performing adjustment of the drive control parameter as described above for each of the plurality of motors.

That is, the drive information of a plurality of the motors 11 detected by the detection unit 13 is transmitted to the single calculation unit 21, the calculation unit is configured to perform adjustment of the drive control parameter for each of the motors based on the drive information, and the drive control parameter after the adjustment is transmitted to and set in the drive circuit with respect to each of the motors.

This configuration makes it possible to adjust the drive control of the plurality of motors 11 in the electrical appliance 1 by a single calculation unit 21.

Further, adjustment of the drive control parameter of the plurality of motors 11 as described above may be performed for each of a plurality of multifunction devices 1. In such a case, a plurality of measuring/writing devices 3 are provided for the plurality of multifunction devices 1 respectively, and the plurality of measuring/writing devices 3 are connected to a single PC 2. That is, a single PC 2 is used in common for the plurality of multifunction devices 1 and the plurality of measuring/writing devices 3. For example, a support staff member can visit different customers with a single PC 2 to provide support for the multifunction devices 1 owned by the different customers by connecting the single PC 2 with the measuring/writing devices 3 at the different customers.

That is, the drive information of a plurality of the motors 11 detected by the detection unit 13 in a plurality of the electrical appliances 1 is transmitted to the single calculation unit 21.

With this configuration, the drive control of the plurality of motors 11 of the plurality of electrical appliances 1 can be adjusted by a single calculation unit 21.

In the example embodiment in which adjustment of the drive control parameter is performed for each of the plurality of motors 11 in the multifunction device 1 as described above, the calculation unit 21 may cause the HDD 231 (an example of the recording unit 23) to record the drive information before the adjustment of the drive control parameter together with the command value. At this time, the calculation unit 21 causes the HDD 231 to record the drive control parameter after the adjustment.

In this case, the drive information, the command value, and the drive control parameter after adjustment are recorded in the HDD 231 every time adjustment of the drive control parameter is performed for one of the motors 11. As a result, various information is accumulated in the HDD 231. Thereafter, when adjustment of the drive control parameter for another motor 11 is performed, the calculation unit 21 acquires drive information of the another motor 11 detected by the encoder 131 before performing the adjustment of the drive control parameter. Then, the calculation unit 21 searches the accumulated information in the HDD 231 for the motor 11 having the same drive information as the acquired drive information.

In the case where the motor 11 having the same drive information as the acquired drive information is found, the calculation unit 21 transmits the drive control parameter after the adjustment of the motor 11 thus found as it is to the microcomputer 12A via the measuring/writing device 3 as the drive control parameter after the current adjustment. This makes it possible to perform adjustment of the drive control parameter efficiently by utilizing the information previously accumulated in the HDD 231 by performing adjustment of the drive control parameter of the other motors 11.

The calculation unit 21 may compare the drive information recorded in the HDD 231 and the current drive information, and calculate the drive control parameter after the current adjustment based on the drive control parameter after adjustment recorded in the HDD 231.

That is, when the calculation unit 21 performs adjustment of the drive control parameter with respect to one of the motors 11, the calculation unit may refer to the drive information of another one of the motors 11 that is different from the one of the motors. This makes it possible to efficiently perform adjustment of the drive control parameter.

Further, the calculation unit 21 may search for another one of the motors 11 having drive information identical to that of the one of the motors 11, and may utilize the drive control parameter after the adjustment with respect to the another one of the motors thus found for the drive control parameter of the one of the motors. This makes it possible to easily perform adjustment of the drive control parameter.

The above example embodiment utilizing the previously accumulated information can also be applied to an example embodiment for optimizing drive control of the plurality of motors 11 in the plurality of multifunction devices 1. In this case, information on the plurality of motors 11 in the plurality of multifunction devices 1 is accumulated and recorded in a single HDD 231. That is, in performing adjustment of the drive control parameter of one of the motors 11 in one of the multifunction devices 1, previously acquired drive information on another motor 11 in another multifunction device 1 may be used.

The encoder 131 may be detached from the motor 11 after completing the setting of the drive control parameter after the adjustment. With this configuration, the encoder 131 with high detection accuracy can be used when performing adjustment of the drive control parameter, and then the encoder 131 is detached after the adjustment, and thus the weight of the multifunction device 1 can be reduced.

That is, the detection unit 13 configured to detect the drive information in a state of being attached to the motor 11 is detachable from the motor. This makes it possible to reduce the weight of the electrical appliance 1.

Further, an analysis device 2 is configured to communicate with an electrical appliance including: a motor 11; a drive circuit 12; and a detection unit 13. The drive circuit 12 is configured to drive the motor 11 based on a rewritable drive control parameter. The detection unit 13 is configured to detect drive information of the motor 11. The analysis device 2 includes a calculation unit 21. The calculation unit 21 is configured to receive the drive information detected by the detection unit 13, and perform adjustment of the drive control parameter based on the drive information thus received. The calculation unit 21 is configured to transmit the drive control parameter after the adjustment to the drive circuit 12. This makes it possible to automatically perform adjustment of a drive control parameter according to a disturbance factor due to an individual characteristic of the motor 11 and an individual characteristic of the electrical appliance 1, and thus the driving control of the individual motor 11 is adjusted easily.

The calculation unit 21 is configured to receive the drive information of the plurality of motors 11 detected by the detection unit 13, and perform adjustment of the drive control parameter for each of the motors 11 based on the drive information. The calculation unit 21 is configured to transmit the drive control parameter after the adjustment to the drive circuit 12 with respect to each of the motors 11. This makes it possible to adjust the drive control of the plurality of motors 11 in the electrical appliance 1 with a single calculation unit 21.

The calculation unit 21 is configured to receive the drive information of the plurality of motors 11 detected by the detection unit 13 in the plurality of electrical appliances 1. This makes it possible to adjust the drive control of the plurality of motors 11 in the plurality of electrical appliances 1 with a single calculation unit 21.

When the calculation unit 21 performs adjustment of the drive control parameter with respect to one of the motors 11, the calculation unit 21 may refer to the drive information of another one of the motors 11 that is different from the one of the motors 11. This makes it possible to efficiently perform adjustment of the drive control parameter.

The calculation unit 21 may search for another one of the motors 11 having drive information identical to that of the one of the motors 11, and may utilize the drive control parameter after the adjustment with respect to the another one of the motors 11 thus found for the drive control parameter of the one of the motors 11. This makes it possible to easily perform adjustment of the drive control parameter.

An electrical appliance according to the present example embodiment includes: a motor 11; and a detection unit 13 configured to detect drive information of the motor 11. The, the electrical appliance 1 is configured to output the drive information detected by the detection unit 13 to an outside of the electrical appliance 1. This makes it easy to output, to the outside, information on a disturbance factor due to an individual characteristic of the motor 11 and an individual characteristic of the electrical appliance 1.

The electrical appliance 1 includes a plurality of motors 11, and the electrical appliance 1 is configured to output the drive information of the plurality of motors 11 detected by the detection unit 13 to the outside of the electrical appliance 1. This makes it easy to output, to the outside, information on a disturbance factor due to an individual characteristic of each of the plurality of motors 11 and an individual characteristic of the electrical appliance 1.

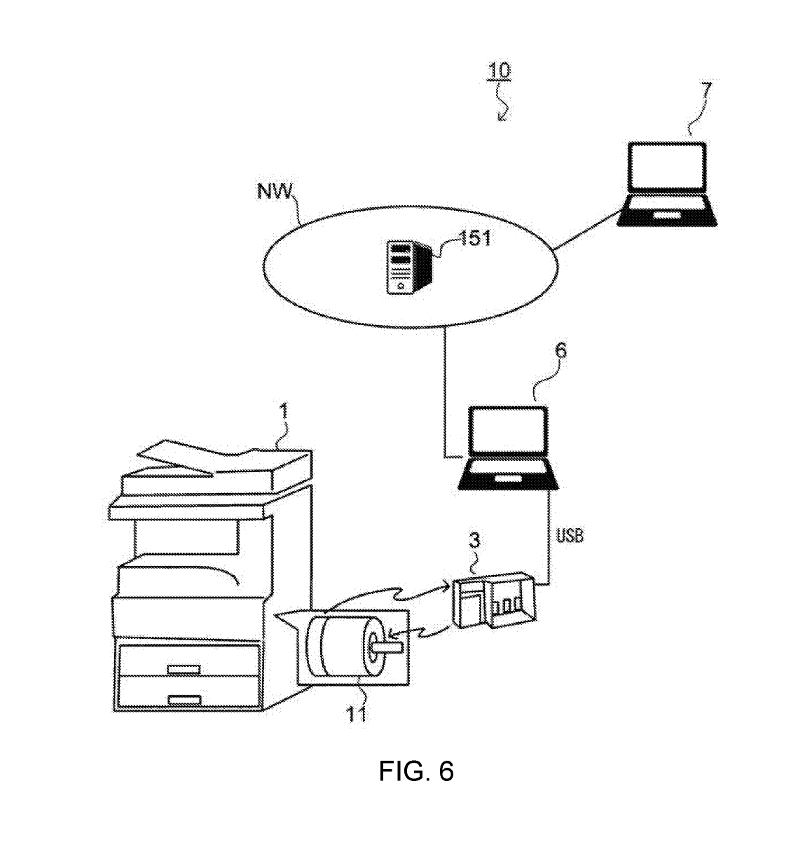

Next, a second example embodiment that is a modification of the first example embodiment will be described. FIG. 6 is a schematic diagram showing an appearance configuration of a motor system according to a second example embodiment of the present disclosure. A motor system 10 according to the second example embodiment includes a multifunction device 1 as an example of an electrical appliance, a measuring/writing device 3, a first PC 6, and a second PC 7 as an example of an analysis device. The PC 6 and the PC 7 communicate with each other via a server 151 on the Internet NW.

For example, the multifunction device 1, the measuring/writing device 3, and the first PC 6 are installed in an office or the like of a customer, and the second PC 7 is installed in an office or the like of a service provider.

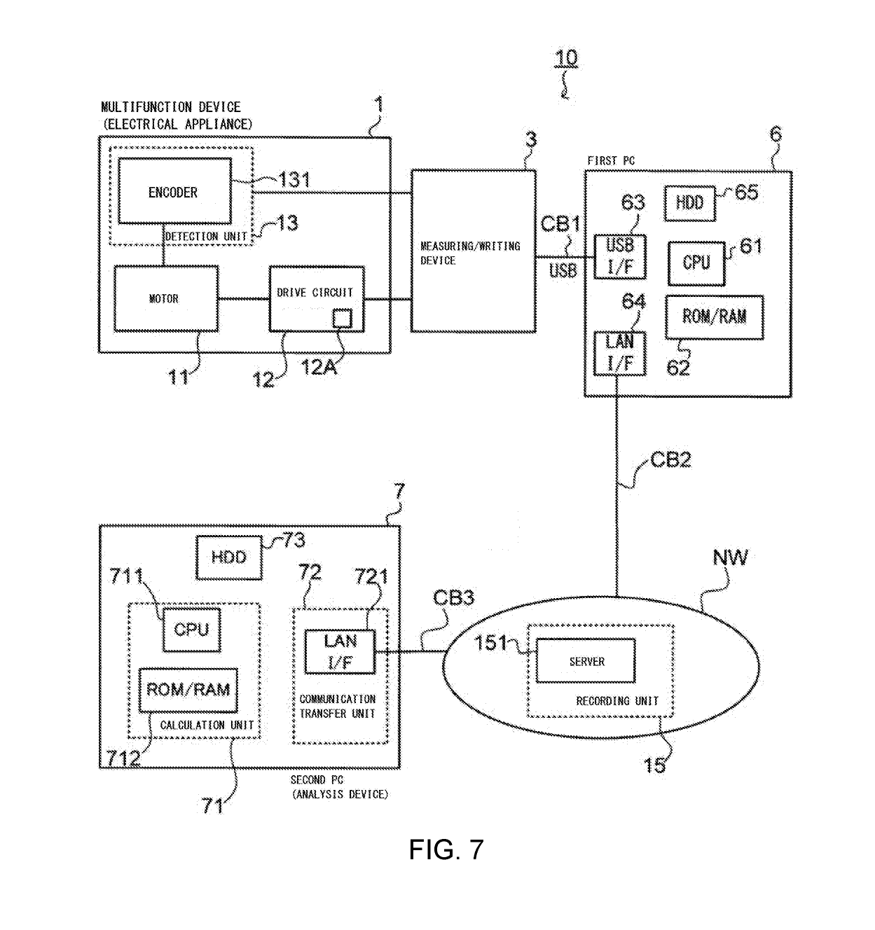

FIG. 7 is a block diagram of the motor system 10 shown in FIG. 6. The multifunction device 1 and the measuring/writing device 3 have the same configuration as those of the first example embodiment (FIG. 3). The first PC 6 includes a CPU 61, a ROM/RAM 62, a USB interface 63, a local area network (LAN) interface 64, and an HDD 65. The USB interface 63 is connected to a USB port of the measuring/writing device 3 by the USB cable CB1. The LAN interface 64 is connected to a router or the like by a LAN cable CB2, and is connected to the Internet NW via the router or the like.

The CPU 61 executes various programs stored in the HDD 65 to perform various processing. The programs include a control program for operating the measuring/writing device 3.

The second PC 7 includes a calculation unit 71, a LAN interface 721, and an HDD 73. The calculation unit 71 includes a CPU 711 and a ROM/RAM 712. The LAN interface 721 is an example of a communication transfer unit 72.

The LAN interface 721 is connected to a router or the like by a LAN cable CB3, and is connected to the Internet NW via the router or the like. That is, the communication transfer unit 72 is formed of a wired LAN interface, but is not limited thereto, and may be formed of a wireless LAN interface, for example.

In the above-described first example embodiment (FIG. 3), the drive information and the drive control parameter are transmitted between the multifunction device 1 and the PC 2 in the process of optimizing the drive control of the motor 11. According to the present example embodiment, the drive information is transmitted, in the same manner as the first example embodiment, from the encoder 131 to the calculation unit 71 through the measuring/writing device 3, the USB interface 63, the LAN interface 64, the server 151, and the LAN interface 721 in the process of optimizing the drive control of the motor 11. At this time, the drive information is recorded in the server 151 that functions as the recording unit 15. Further, according to the present example embodiment, the drive control parameter is transmitted, in the same manner as the first example embodiment, from the calculation unit 71 to the drive circuit 12 through the LAN interface 721, the server 151, the LAN interface 64, the USB interface 63, and the measuring/writing device 3. At this time, the drive control parameter is recorded in the server 151.

That is, the drive information detected by the detection unit 13 is transmitted to the calculation unit 71 via a network NW, and the drive control parameter after the adjustment is transmitted to and set in the drive circuit 12 via the network. This makes it possible to remotely optimize the driving control of the motor 11 in the electrical appliance 1 by using the analysis device 7. For example, it becomes unnecessary for a service provider to send a supporting staff member to their customers.

Note that the network is not limited to the Internet, and for example, the first PC 6 and the second PC 7 may be connected with each other via a LAN. In this case, there may be a situation where the multifunction device 1 and the second PC 7 are installed in different rooms in the same building, for example.

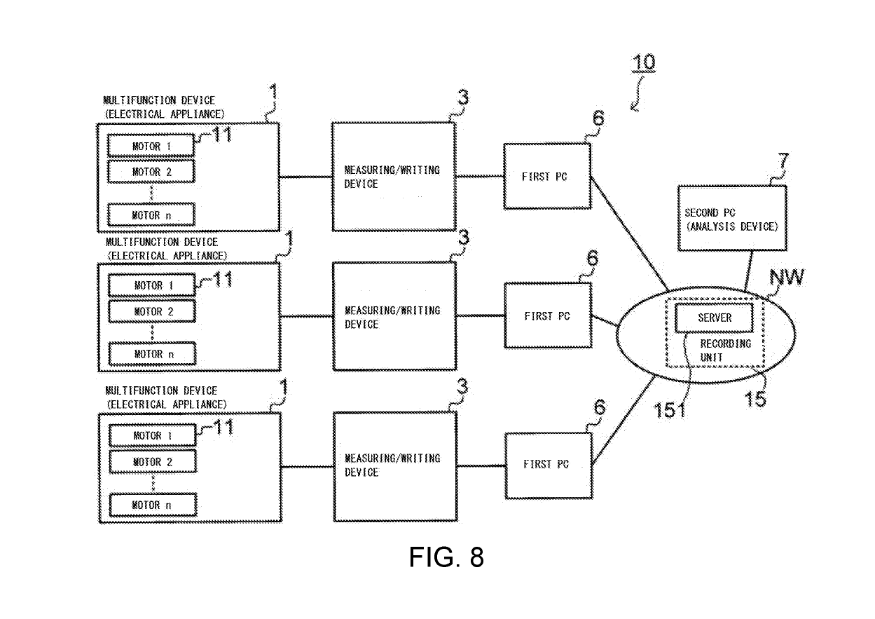

FIG. 8 is an overview showing one example embodiment of the motor system 10 according to the present example embodiment. In the motor system 10 in FIG. 8, a plurality of multifunction devices 1 are connected to the Internet NW via the measuring/writing devices 3 and the first PCs 6, respectively. A single second PC 7 is connected to the Internet NW. Each of the plurality of multifunction devices 1 includes a plurality of motors 11. In each of the multifunction devices 1, the drive circuit 12 and the encoder 131 are provided for each of the plurality of motors 11.

For example, the multifunction device 1, the measuring/writing device 3 and the first PC 6 are installed as a set in each office or the like of different customers, and the second PC 7 is installed in an office or the like of a service provider.

With this configuration, in optimizing the drive control of the plurality of motors 11 in each of the plurality of multifunction devices 1, the drive information is transmitted from the encoder 131 in each of the motors 11 in the multifunction devices 1 to the calculation unit 71 of the second PC 7 via the measuring/writing device 3, the first PC 6, and the server 151. At this time, the drive information is recorded in the server 151 that functions as the recording unit 15. The drive control parameter is transmitted from the calculation unit 71 of the second PC 7 to the drive circuit 12 of each of the motors 11 in the multifunction devices 1 via the server 151, the first PC 6, and the measuring/writing device 3. At this time, the drive control parameter is recorded in the server 151.

That is, the drive information detected by the detection unit 13 is transmitted to the calculation unit 71 via a server 151 on the network NW, the drive control parameter after the adjustment is transmitted to and set in the drive circuit 12 via the server, and the server is configured to accumulate the drive information and the drive control parameter.

This makes it possible to effectively utilize the drive information and the drive control parameter accumulated in the server. In optimizing the drive control of one of the motors 11, for example, if the drive information of the one of the motors is the same as that of another one of the motors 11 recorded in the server 151 at the time of optimizing the drive control of the another one of the motors 11, the drive control parameter after the adjustment of the another one of the motors 11 recorded in the server 151 can be utilized as it is for the current drive control parameter after the adjustment. This makes it possible to optimize the drive control of the motors 11 by efficiently utilizing the information previously recorded in the server 151.

Further, a service provider can record information on reports to their customers in the server 151 and link them with the drive information and the drive control parameter accumulated in the server 151, for example. It is also possible for the customers to access the server 151 from their own terminal and acquire the information accumulated in the server 151.

That is, the calculation unit 71 is configured to receive the drive information via a network, and transmit the drive control parameter after the adjustment to the drive circuit 12 via the network. This makes it possible to remotely optimize the drive control of the motors 11 in the electrical appliance 1 by using the analysis device 7. For example, it becomes unnecessary for a service provider to send a supporting staff member to their customers.

The calculation unit 71 is configured to receive the drive information via a server 151 on the network, and transmit the drive control parameter after the adjustment to the drive circuit 12 via the server 151. In the analysis device 7 according to the present example embodiment, the server 151 is configured to accumulate the drive information and the drive control parameter. This makes it possible to effectively utilize the drive information and the drive control parameter accumulated in the server 151.

According to the above described example embodiments of the present disclosure, there is provided a motor control method for a motor system 5, 10 including: an electrical appliance 1 including: a motor 11; a drive circuit 12 configured to drive the motor based on a rewritable drive control parameter; and a detection unit 13 configured to detect drive information of the motor; and an analysis device 2, 7 having a calculation unit 21, 71, wherein the motor control method includes: a transmitting step of transmitting the drive information detected by the detection unit to an outside of the electrical appliance, and to the calculation unit; an adjusting step of allowing the calculation unit to perform adjustment of the drive control parameter based on the drive information thus transmitted; and a setting step of transmitting and setting the drive control parameter after the adjustment in the drive circuit.

According to the above motor control method, in the transmitting step, the drive information of a plurality of the motors detected by the detection unit may be transmitted to the single calculation unit, in the adjusting step, the calculation unit may perform adjustment of the drive control parameter for each of the motors based on the drive information, and in the setting step, the drive control parameter after the adjustment may be transmitted to and set in the drive circuit with respect to each of the motors.

Further, in the transmitting step, the drive information of a plurality of the motors detected by the detection unit in a plurality of the electrical appliances may be transmitted to the single calculation unit.

In any one of the above motor control methods, in the adjusting step, when the calculation unit performs adjustment of the drive control parameter with respect to one of the motors, the calculation unit may refer to the drive information of another one of the motors that is different from the one of the motors.

Further, in the adjusting step, the calculation unit may search for another one of the motors having drive information identical to that of the one of the motors, and may utilize the drive control parameter after the adjustment with respect to the another one of the motors thus found for the drive control parameter of the one of the motors.

According to any one of the above motor control methods, in the transmitting step, the drive information detected by the detection unit may be transmitted to the calculation unit via a network NW, and in the setting step, the drive control parameter after the adjustment may be transmitted to and set in the drive circuit via the network.

Further, in the transmitting step, the drive information detected by the detection unit may be transmitted to the calculation unit via a server 151 on the network, in the setting step, the drive control parameter after the adjustment may be transmitted to and set in the drive circuit via the server, and the server may store the drive information and the drive control parameter.

Further, any one of the above motor control methods may further include a detaching step of detaching the detection unit from the motor, the detection unit being configured to detect the drive information in a state of being attached to the motor.

For example, optimization of the drive control of the motors can be performed not only at the time of installation of electrical appliances (such as the multifunction device 1, but periodically thereafter (e.g. every month, or the like). This makes it possible to deal with a case where a characteristic of a disturbance factor due to an individual characteristic of the motor and an individual characteristic of the electrical appliance has been changed, which leads to extension of the life of the electrical appliance.

The present disclosure can be suitably used for, for example, a motor system, an analysis device, and an electrical appliance which include an image forming device.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor system comprising:
an electrical appliance including:
a motor;
a drive circuit to drive the motor based on a rewritable drive control parameter; and
a detector to detect drive information of the motor; and
an analyzer including a calculator; wherein the drive information detected by the detector is output to an outside of the electrical appliance and transmitted to the calculator;
the calculator performs adjustment of the drive control parameter based on the drive information transmitted; and
the drive control parameter after the adjustment is transmitted to and set in the drive circuit.

2. The motor system according to claim 1, wherein
the drive information of a plurality of the motors detected by the detector is transmitted to the calculator;
the calculator performs adjustment of the drive control parameter for each of the motors based on the drive information; and
the drive control parameter after the adjustment is transmitted to and set in the drive circuit with respect to each of the motors.

3. The motor system according to claim 2, wherein the drive information of the plurality of the motors detected by the detector in a plurality of the electrical appliances is transmitted to the calculator.

4. The motor system according to claim 2, wherein, when the calculator performs adjustment of the drive control parameter with respect to one of the motors, the calculator refers to a drive information of another one of the motors that is different from the one of the motors.

5. The motor system according to claim 4, wherein the calculator searches for another one of the motors having drive information identical to that of the one of the motors, and utilizes the drive control parameter after the adjustment with respect to the another one of the motors for the drive control parameter of the one of the motors.

6. The motor system according to claim 1, wherein the drive information detected by the detector is transmitted to the calculator via a network; and
the drive control parameter after the adjustment is transmitted to and set in the drive circuit via the network.

7. The motor system according to claim 6, wherein
the drive information detected by the detector is transmitted to the calculator via a server on the network;
the drive control parameter after the adjustment is transmitted to and set in the drive circuit via the server; and
the server accumulates the drive information and the drive control parameter.

8. The motor system according to claim 1, wherein the detector detects the drive information while detachably attached to the motor.

9. An analyzer to communicate with an electrical appliance including a motor, a drive circuit to drive the motor based on a rewritable drive control parameter, and a detector to detect drive information of the motor, the analyzer comprising:
a calculator; wherein
the calculator is configured or programmed to receive the drive information detected by the detector, perform adjustment of the drive control parameter based on the drive information received, and transmit the drive control parameter after the adjustment to the drive circuit.

10. The analyzer according to claim 9, wherein the calculator is configured or programmed to receive the drive information of a plurality of the motors detected by the detector, perform adjustment of the drive control parameter for each of the motors based on the drive information, and transmit the drive control parameter after the adjustment to the drive circuit with respect to each of the motors.

11. The analyzer according to claim 10, wherein the calculator is configured or programmed to receive the drive information of a plurality of the motors detected by the detector in a plurality of the electrical appliances.

12. The analyzer according to claim 10, wherein, when the calculator performs adjustment of the drive control parameter with respect to one of the motors, the calculator refers to a drive information of another one of the motors that is different from the one of the motors.

13. The analyzer according to claim 12, wherein the calculator is configured or programmed to search for another one of the motors having drive information identical to that of the one of the motors, and the calculator is configured or programmed to utilize the drive control parameter after the adjustment with respect to the another one of the motors for the drive control parameter of the one of the motors.

14. The analyzer according to claim 9, wherein the calculator is configured or programmed to receive the drive information via a network, and transmit the drive control parameter after the adjustment to the drive circuit via the network.

15. The analyzer according to claim 14, wherein
the calculator is configured or programmed to receive the drive information via a server on the network, and transmit the drive control parameter after the adjustment to the drive circuit via the server;
the server is configured or programmed to accumulate the drive information and the drive control parameter.

16. An electrical appliance comprising:
a motor; and
a detector to detect drive information of the motor; wherein
the electrical appliance outputs the drive information detected by the detector to an outside of the electrical appliance.

17. The electrical appliance according to claim 16, further comprising a plurality of the motors, wherein the electrical appliance outputs the drive information of the plurality of the motors detected by the detector to the outside of the electrical appliance.

18. The electrical appliance according to claim 16, wherein the detector detects the drive information while detachably attached to the motor.
